(19) United States
(12) Patent Application Publication
(10) Pub. No.: US 2015/0027563 A1
(43) Pub. Date: Jan. 29, 2015

(54) VALVES

(71) Applicant: CHARGEPOINT TECHNOLOGY LIMITED, Liverpool, Merseyside (GB)

(72) Inventor: Richard Athol Barton, Manchester (GB)

(21) Appl. No.: 14/380,800

(22) PCT Filed: Feb. 28, 2013
(86) PCT No.: PCT/GB2013/050500

§ 371 Date: Aug. 25, 2014

(30) Foreign Application Priority Data
Feb. 29, 2012 (GB) 1203559.8

(51) Int. Cl. F16K 5/04; F16K 5/06; F16K 35/10

(52) U.S. Cl. CPC F16K 5/0407; F16K 35/10; F16K 5/0605
USPC 137/385; 251/367

(57) ABSTRACT

A split valve assembly (10) comprising two valve portions (12, 14) complementarily shaped such that the first can sealingly engage with and co-operate with the second to allow the movement of material therethrough. Each valve portion (12, 14) comprises a housing (16, 18), a valve seat and a valve closure member (20, 20′). The assembly has a first configuration in which the first and second valve portions engage with one another, the valve closure members being closed, and a second configuration in which the two valve portions are disengaged from one another. The first valve portion has locking means (60) moveable relative to the second valve portion to selectively lock and unlock the two valve portions together. The locking means are received by the second valve portion, which comprises a shim.

The present invention relates to valves, and in particular, but not exclusively, to valves for controlling, charging, discharging and/or regulating the flow of powders, liquids, slurries and/or fluids.

Valves, such as split butterfly valves, are available in many designs and used widely for processes where product containment is required to prevent product exposure to environment and personnel working in close proximity of the product. The split valves are designed pre-dominantly for handling and contained transfer of solid state powders and granular material alike.

Split valve design allows the valve to be split open into two halves, commonly called alpha and beta halves, or active and passive halves. The valve design is such that when split, the two halves keep the contents on either side sealed and contained, and also protected from the environment.

Similar to the split butterfly valve, a split ball valve can also be used for contained transfer of solids and more commonly liquids. Historically, these valves have mainly been used in pharmaceutical and biotech industries for non-sterile operations.

The material being handled is often hazardous to health, owing to the increasing potency of many new pharmaceutical ingredients, Pharmaceutical and bio-manufacturing products are often manufactured under strict controls against product contamination. This is because the products are often for human consumption and the industries are heavily regulated by bodies like the FDA (Food and Drug Administration) in the United States and the MHRA (Medicines and Healthcare products Regulatory Agency) in the United Kingdom. Furthermore, the pharmaceutical products, such as active pharmaceutical ingredients and/or subsequently diluted powders, may in sufficient quantities be hazardous to the health of an operator. It is therefore necessary to avoid direct contact between an operator and the potentially hazardous material.

Owing to such stringent requirements for there to be a good seal between active and passive elements of the split valve to prevent product exposure to environment and personnel working in close proximity of the product, manufacture of the elements of the valve are under stringent conditions to ensure that the dimensions of the elements are precisely manufactured to ensure stringent tolerances are met.

In addition, the valve elements are consequently relatively large often owing to the housing for the valve itself being capable of ensuring that there is a good seal between members. This can make the containers bulky and difficult to handle, particularly when being handled in a glove box containment apparatus where the dexterity of operators is compromised.

WO2010092395 discloses a split butterfly valve having a locking pin and complementarily shaped non-threaded bore for receiving said pin for locking to valve portions of a split valve together, thus enabling the safe transfer of material from one vessel to another, for example. However, the tolerances required for correct alignment of the bore and pin are very small to ensure a good seal between the two valve portions. Consequently, the pin is disposed slightly off-centre of the longitudinal axis of the bore to ensure an excellent interference fit. However, the pin and bore are consequently subject to much more significant wear which can result in the interference fit being impaired over time and with consistent use. Furthermore, it is difficult and costly to machine a complex shape into a hole.

It is an object of the present invention to overcome or alleviate one or more of the problems associated with the prior art.

In accordance with the present invention, there is provided a split valve assembly comprising two valve portions complementarily shaped such that the first can sealingly engage with and co-operate with the second to allow the movement of material therethrough, each valve portion comprising a housing, a valve seat and a valve closure member moveable between a first position in which the valve closure member is displaced from the valve seat and the valve is open, and a second position in which the valve closure member co-operates with the valve seat and the valve is closed, wherein the assembly has a first configuration in which the first and second valve portions engage with one another, the valve closure members being closed, and a second configuration in which the two valve portions are disengaged from one another, the first valve portion having locking means moveable relative to the second valve portion to selectively lock and unlock the two valve portions together, said locking means received by the second valve portion which comprises a shim.

The present invention provides a valve assembly capable of ensuring a secure and good seal therebetween and which has a simplified mechanism for engagement and securing valve portions together to provide an improved valve system.

The locking means may comprise a locking pair, one member of which is moveable relative to the other and capable of selectively engaging with the other member to lock and unlock portions together.

The locking pair may comprise a male and female member complementarily shaped to one another. The male member is preferably moveable relative to the female member.

The male member is preferably capable of translational movement.

In one embodiment, the male member comprises a pin and the female member comprises a complementarily shaped blind bore for receiving the male member,

The male member is preferably disposed in the active valve portion and the female in the passive valve portion.

The shim receives the pin and displaces it in a direction perpendicular to its longitudinal axis resulting in a more secure and better seal between valve portions.

The longitudinal axis of the male member may be of from that of the female member. Consequently, when the male member engages and is received by the female member, the valve portions are squeezed together to form a better seal therebetween.

Preferably, the shim is releasably secured in the second valve portion.

More preferably, the means for releasably securing the shim to the second valve portion comprises fastening means.

Preferably, the fastening means is a screw.

The shim may be replaceable to improve the life of the valve.

The shim may be manufactured from a different material to that of the pin. This improves part life reducing friction and wear.

The shim may be manufactured from a material having less tensile strength than the pin. This may facilitate extension of the valve life as the shim is likely to wear/fail before the pin.

The shim may comprise a base and a wedge portion.

The wedge portion is preferably orientated such that the thin end is proximal to the bore opening.

The wedge portion may taper from the end of the bore, distal to the opening.

The base of the shim may comprise an aperture through which securing means may pass to secure the shim in place.

The tapered profile of the wedge portion allows the two discs to be forced together in a controlled way as the pin extends into the bore and engages with the distal end of the wedge portion. This improves the valve's containment performance.

The face of the wedge portion for engagement with the pin is complementarily shaped. The wedge is preferably curved. One side of the shim is conformed/shaped to conform with curvature of the pin, the other side shaped to conform to the curvature of the bore.

One side of the shim is arcuate and adapted to be one third to half a complete circle circumference.

The shim is preferably tapered.

The shim has a top bearing surface formed from a first radius of curvature and the lower surface being a second radius of curvature that is greater than the first.

Radius of first radius of curvature, is preferably substantially the same as the radius of the male member.

The radius of the shim is substantially the same as the female member.

The arc length of the shim is from about one quarter to one half of the circumference of a circle defined by the arcuate section.

The shim may have an extraction hole which is accessible external to the shim for engagement with a tool for the insertion and/or removal of the shim.

The shim is preferably forced into position.

The shim is preferably held in position with a retaining fastener.

The shim is may be resiliently deformable to allow insertion and then to conform to the desired shape.

The male member and wedge portion may be complimentarily shaped. This maximises the contact area to reduce wear and damage to the pin and bore of the valves.

In one embodiment the first and second valve portions may be both female members, there being a third valve portion having corresponding male members which the female members can receive.

Each valve portion of the assembly may be mountable on a vessel for containing material, conveyance means, such as a hose, for conveying material and/or other process equipment known to the art. The means for mounting the valve portions may comprise any means known to the art, such as for example a screw thread, interference fit, female:female attachment etc. in an alternative embodiment, the valve portions may be integrally formed with a vessel or conveyance means.

The inlet and outlet of the chamber may be closed once the movement from the first to the second configuration is complete. In so doing, the assembly ensures that the material being transferred therethrough does not come into contact with the surrounding environment.

The valve seat and valve closure member are preferably complementarily shaped to ensure that a seal is formed when the valve closure member is closed.

The valve assembly may be a split butterfly valve, split ball valve, any other split valve or quick release coupling known to the art. Preferably, the assembly is a split butterfly valve.

Preferably, the valve portions form a mating pair, one being a male or active valve portion, the other female or passive.

Preferably, the valve seat comprises a seal member. The seal member may preferably comprise an abutment portion and a resiliently deformable portion located between the abutment portion and the valve housing.

In an alternative embodiment, the valve closure member may be provided with a recess for receipt of a seal which, in use, is adapted to engage against a solid portion of the valve housing.

In the case where the seal is located in a recess in the valve closure member the valve closure member may further comprise an elastomeric material covering the valve closure member and the seal located thereon.

In one embodiment, the valve closure member being pivotable beyond the position in which further displacement is normally prevented by engagement with the valve seal, the valve may further comprise biassing means for biassing the valve closure member into its closed position.

The valve seal may be located either on the valve housing or on the valve closure member.

During use, the assembly may be switched from the first to the second configuration to allow material to be transferred therethrough. Once the material has been transferred, the assembly is switched back to the first configuration and the two valve portions disengaged.

The shim preferably has a special and highly toleranced shape and profile (which is complimentary to the Locking Pin shape) to exert carefully controlled forces on the valve portions to hold them tightly together when the Locking Pins are extended and in the locked configuration. This controlled force is crucial to improving containment performance and easing operation.

The valve portions may be manufactured from 316L and 304 Stainless Steel, Alloy 22 and C276 Nickel alloys.

The Locking Pins may be manufactured from materials that resist wear, for example Aluminium Bronze, Phosphor Bronze, other Bronze grades, hard specialty grades of stainless steel, such as 431 and 17-4PH.

The locking pins may also comprise a coating. The coating material may comprise Diamond Like Coating (DLC) and/or plastic coatings, such as, PEEK, PTFE and other grades.

The shim may be manufactured from 316L or 304 Stainless Steel, or one of the harder specialty grades of stainless steel such as 431 or 17-4PH.

By way of example only, a specific embodiment of the present invention will now be described, with reference to the accompanying drawings, in which:

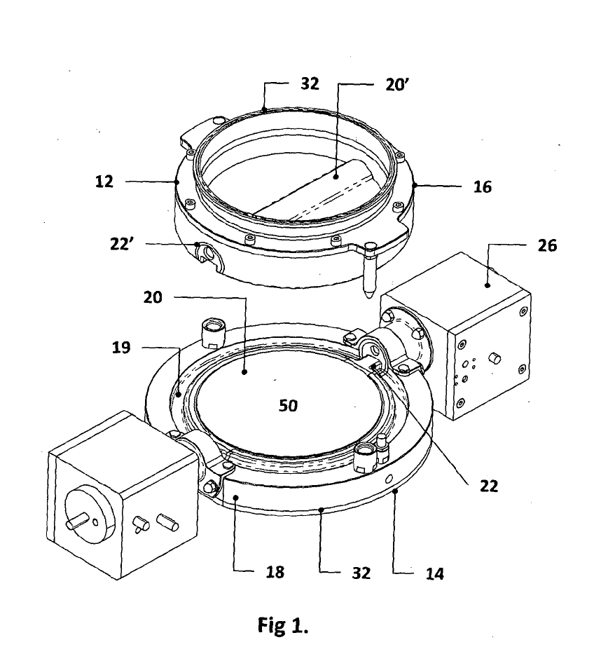

FIG. 1 is a perspective view of the two valve portions of a butterfly valve;

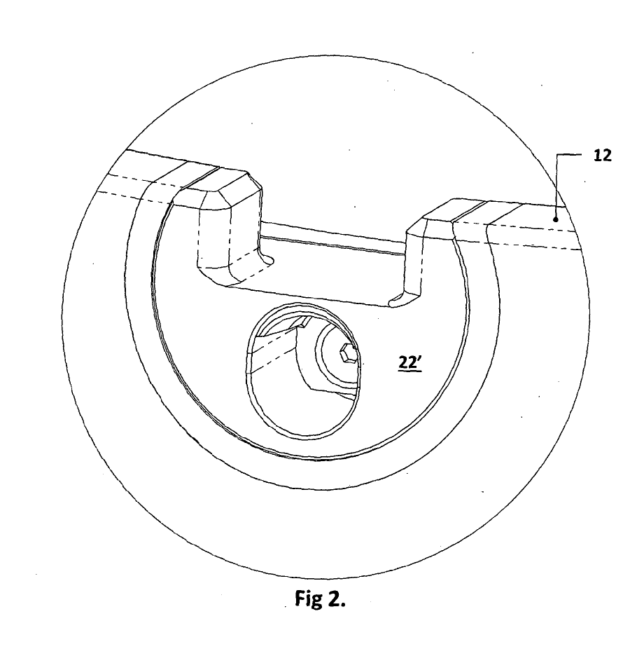

FIG. 2 is a partial view of second valve portion of a valve assembly in accordance with the present invention;

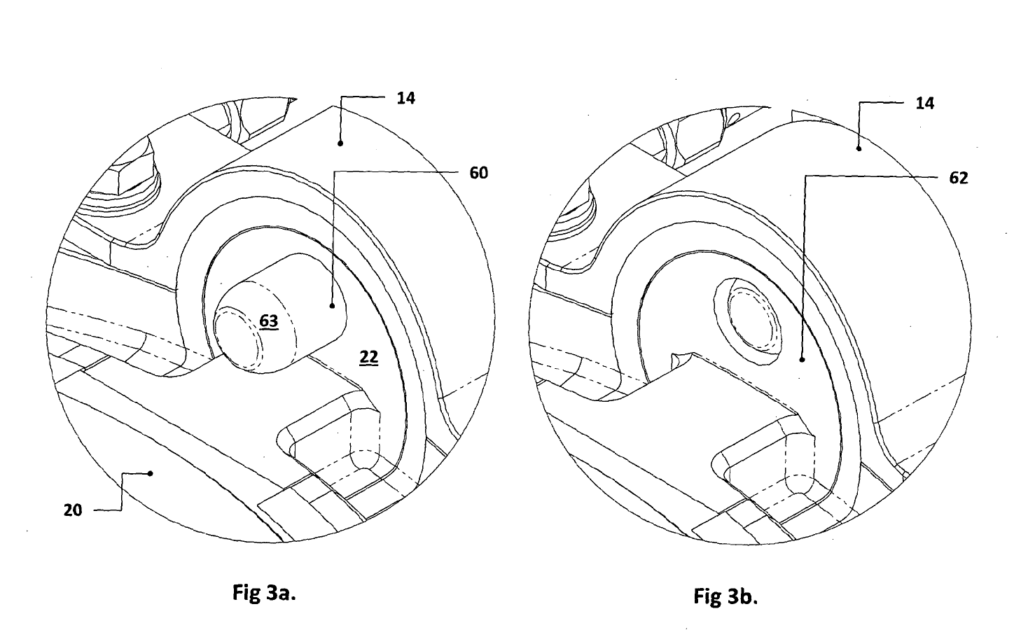

FIGS. 3a and b are partial views of a first valve portion of a valve assembly in accordance with the present invention in its first configuration and second configuration respectively;

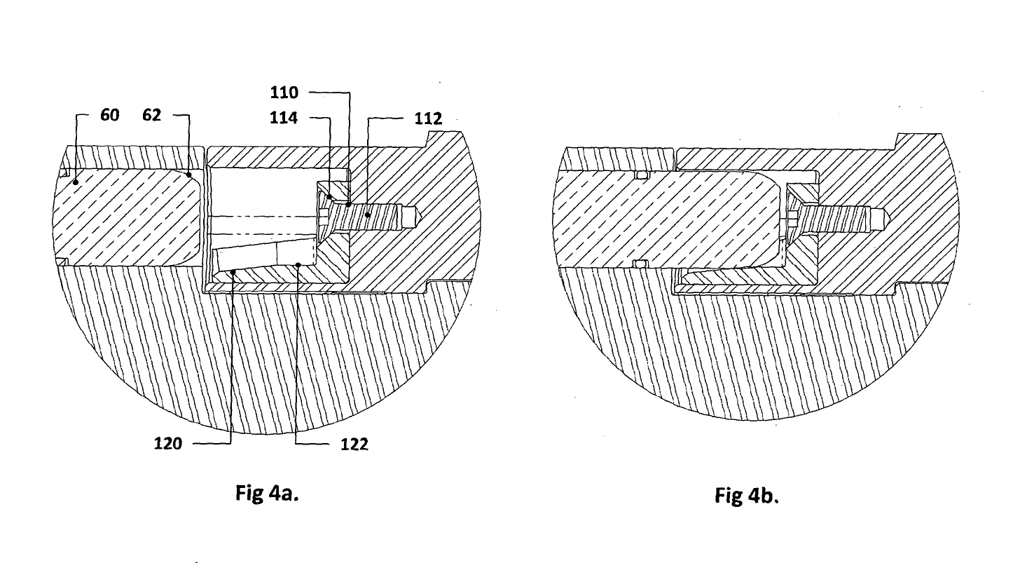

FIGS. 4a and b are sectional views of the active portion of a valve assembly engaging with a passive portion of the valve assembly in accordance with the present invention;

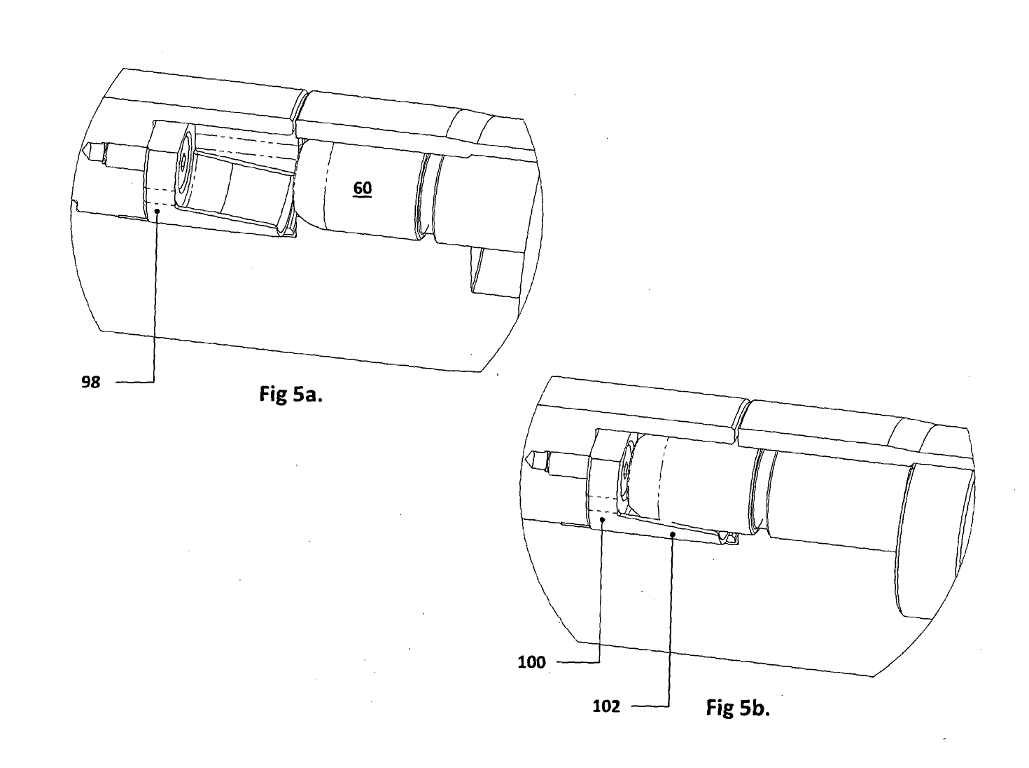

FIGS. 5a and b show a cut away section through the active valve portion of FIGS. 1-3;

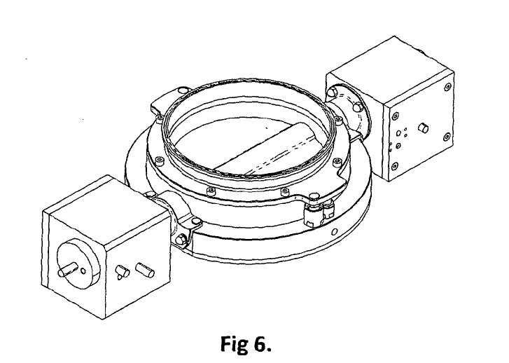

FIG. 6 shows two valve portions in an engaged configuration; and

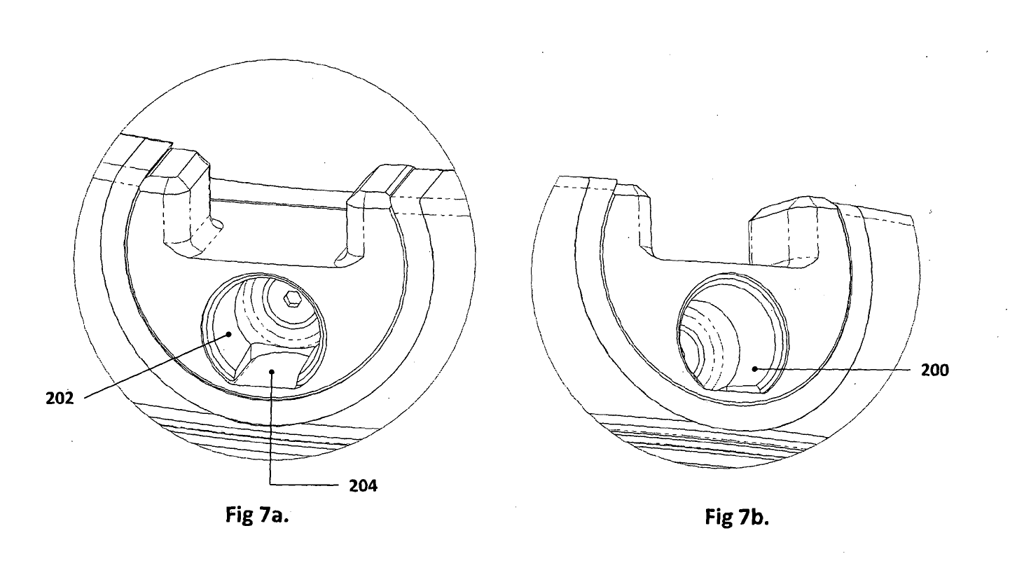

FIGS. 7a and b are partial views of a passive portion of a passive portion of a valve assembly in accordance with the present invention.

Referring firstly to FIGS. 1 to 6, the valve assembly 10 comprises two valve portions, an upper, passive and lower, active valve portion 12,14, each having a valve housing indicated generally at 16, 18 which are generally annular and a valve closure member 20, 20 which is pivotally mounted within the housing. Valve housing 18 has an annular recess 19. The valve closure member 20,20′ is in the form of an annular disc and is provided with spindles 22,22′ by means of which the valve closure member is pivotally mounted within the housing. The valve closure member 20,20′ and the spindles 22,22′are machined from a single piece of metal.

One of the spindles 22 of the lower valve closure member 18 is operatively connected to actuator 28. Thus, the annular disc is journalled for rotation on the spindles 22,22′ and is moved by the spindle. An automatic actuator 26 is received on an opposite end to the annular disc of the spindle 22. Two actuators may be employed, one either side of the spindle of the active valve portion or a manual actuator can be used in an alternative embodiment.

The valve closure member 20,20′ is engageable with and disengageable from an annular valve seat in the form of an annular seal (not shown) which is seated in a complimentarily-shaped recess in the valve housing. The seal comprises a EPDM annular abutment portion (alternatively, perfluoroelastomer or any other suitable material can be used) which, in use, engages the valve closure member 20,20′.

The outer end face of each of the valve housing portions 18, 18 is planar and in use each face is connected to, for example, adjacent piping sections or a vessel in a manner well known to in the art and a through passage is formed by means of, for example, aligned bores.

The abutment of the two valve housing portions 16,18 form a mating pair such that the upper valve portion 16 is mounted within the lower valve housing portion 18, the upper valve portion 16 being male and the lower valve portion 18 being female. In a first configuration (see FIG. 2) the two valve portions are engaged, such that the valve closure members are sealed from the surrounding environment and that material to be transferred through the valve will not be contaminated by the surrounding environment.

The active or male portion 14 of the valve 10 has two moveably mounted locking pin 60 diametrically opposite one another and located within a housing 62. Each pin 60 is capable of translational movement to move from an unlocking position (see FIG. 3) where the pin is located within the housing 62 to a locking or engaged position whereby the pin 60 extends beyond its housing (see FIG. 4).

The housing 62 forms part of the spindle 22.

There are two complementarily shaped blind bores 64 that are located in the female valve portion 12 each of which is shaped to receive respective pin 60. The blind bores 64 are substantially oval in shape. Each pin has a chamfered edge 63 to facilitate location of the pin in the bores 64.

FIG. 5a and b show the locking member engaging with and disengaging with the female or passive portion of the valve. As can be seen, pin is moveable from a retracted position (FIG. 5a) into an extended position (FIG. 5b) where the pin is received in blind bore.

The shim 98 comprises a base 100 and a wedge portion 102. The profile of the wedge portion is complementarily shaped to that of the tapered end of the pin 60 to facilitate easy entry of the pin into the bore 64 to reduce friction and wear.

The shim 98 forces the locking pin 60 against the inner wall of the bore 64 creating a tighter interference fit. Consequently, the tolerances between the pin 60 and the bore 64 are less critical and as a result manufacturing is simpler and more cost-effective.

The wedge portion 102 tapers from the base 100.

The base 100 of the shim 78 is a substantially circular member having an aperture 110 for receiving a screw 112 which has a circular recess 114 for receiving the head of a screw 112 to ensure that once secured the head of the screw is flush with the plane of the base 100 the screw does not sit proud of the base.

The wedge 102 has two profiles: an inclined region 120 and a plateau region 122.

The shim has a substantially shaped longitudinal cross-section.

The shim has an arcuate wedge portion complementarily shaped to that of the pin.

The valve closure members are adapted to be pivotable through 90 degrees, and when in its fully open position the profile of the inner face 50,50′ of the valve closure member 20,20′ corresponds with the profile of the through bore of the valve housing, thereby creating minimal restrictions for the flow of fluid or other material.

The valve assembly can then be fully engaged in its second configuration, whereby seats 28,28′ mate to form a seal and valve closure members 20,20′ contact one another and can rotate to open each valve portion respectively, which are sealingly engaged thereby allowing the passage of material therethrough without the material becoming contaminated. Rotation of the spindles 22, 22′ of the lower valve closure member 20′ will result in rotation of the upper valve closure member 20′.

In an alternative embodiment, the blind bores located in the female valve portion are substantially circular blind bores 200. FIGS. 7a and b are partial views of such an embodiment. The bores 200 have a substantially circular side wall 202 flattened at the bottom having a recessed support surface 204 upon which the wedge 102 can nest. The support surface 204 is recessed into side wall 202. The recess is shaped to receive arid support the wedge 102.

The valves of the present invention are able to operate in a complete sterile or decontaminated manner, with in one embodiment, an in situ sterilisation or decontamination step before and after each docking, regardless of how many times the valve is split open and re-docked, ensuring sterile conditions on product contact parts before, and if receiving, after each dock and undock.

These barriers can be created by any combination of seals, gaskets, o rings, or seats or inflatable seals.

When the valve is split open into two halves, any material disposed within a vessel etc. will maintain its sterility as each valve portion is sealed from the surrounding atmosphere by the valve closure members.

The invention is not restricted to the details of the foregoing embodiments. For example, the valve actuator may be replaced with a different actuator, such as a manually-operated handle.

An alternative embodiment of the present invention replaces the butterfly valve closure members of the valve with ball closure members.

1. A split valve assembly comprising two valve portions complementarily shaped such that a first portion can sealingly engage with and co-operate with a second portion to allow movement of material therethrough, each valve portion comprising a housing, a valve seat and a valve closure member moveable between a first position in which the valve closure member is displaced from the valve seat and the valve is open, and a second position in which the valve closure member cooperates with the valve seat and the valve is closed, wherein the assembly has a first configuration in which the first and second valve portions engage with one another, the valve closure members being closed, and a second configuration in which the two valve portions are disengaged from one another, the first valve portion having locking means moveable relative to the second valve portion to selectively lock and unlock the two valve portions together, said locking means being received by the second valve portion which comprises a shim.

2. A split valve assembly as claimed in claim 1 wherein the locking means may comprise a locking pair, one member of which is moveable relative to the other member and capable of selectively engaging with the other member to lock and unlock portions together.

3. A split valve assembly as claimed in claim 2 wherein the locking pair may comprise a male and female member complementarily shaped to one another.

4. A split valve assembly as claimed in claim 3 wherein the male member is preferably moveable relative to the female member.

5. A split valve assembly as claimed in claim 4 wherein the male member is capable of translational movement.

6. A split valve assembly as claimed in claim 3 wherein the male member comprises a pin and the female member comprises a complementarily shaped blind bore for receiving the male member.

7. A split valve assembly as claimed in claim 3 wherein the male member is preferably disposed in the active valve portion and the female in the passive valve portion.

8. A split valve assembly as claimed in claim 6 wherein the shim receives the pin and is located in the second valve portion.

9. A split valve assembly as claimed in claim 8 wherein the shim is releasably secured in the second valve portion.

10. A split valve assembly as claimed in claim 9 wherein the means for releasably securing the shim to the second valve portion comprises fastening means.

11. A split valve assembly as claimed in claim 10 wherein the fastening means is a screw.

12. A split valve assembly as claimed in claim 1 wherein the shim is replaceable.

13. A split valve assembly as claimed in claim 1 wherein the shim is manufactured from a different material from that of the male member.

14. A split valve assembly as claimed in claim 1 wherein the shim comprises a base portion and a wedge portion.

15. A split valve assembly as claimed in claim 14 wherein the wedge portion is orientated such that a tapered end is proximal to a bore opening.

16. A split valve assembly as claimed in claim 15 wherein the base portion of the shim comprises an aperture through which securing means may pass to secure the shim in place.

17. A split valve assembly as claimed in claim 6 wherein the pin and wedge portion of the shim are complimentarily shaped.

18. A split valve assembly as claimed in claim 1 wherein the valve assembly is selected from the group consisting of a split butterfly valve, split ball valve, and any other split valve.

19. A split valve assembly as claimed in claim 1 wherein the valve portions are manufactured from 316L and 304 Stainless Steel, Alloy 22 and C276 Nickel alloys.

20. A split valve assembly as claimed in claim 19 wherein a locking pin is manufactured from a material selected from the group consisting of aluminum bronze, phosphor bronze, other bronze grades, and hard specialty grades of stainless steel such as 431 and 17-4PH.

21. A split valve assembly as claimed in claim 20 wherein the shim is manufactured from 316L or 304 Stainless Steel or a harder specialty grade of stainless steel such as 431 or 17-4PH.

22. A shim for a split valve assembly having first and second valve portions and locking means comprising a male member and female member, said shim comprising a base portion and a wedge portion, the wedge portion extending from the base and having a tapered profile, the base having means for securing it to a valve portion.

23. A shim as claimed in claim 22 wherein the male member comprises a pin and the female member comprises a complementarily shaped blind bore for receiving the male member.

24. A shim as claimed in claim 23 wherein the male member is preferably disposed in the active valve portion and the female in the passive valve portion.

25. A shim as claimed in claim 24 having releasable securing means for releasably securing it to a valve portion.

26. A shim as claimed in claim 25 wherein the means for releasably securing the shim to the second valve portion comprises fastening means.

27. A shim as claimed in claim 26 wherein the fastening means is a screw.

28. A shim as claimed in claim 22 wherein the tapered profile is proximal to a bore opening.

29. A shim as claimed in claim 22 wherein the base of the shim comprises an aperture through which securing means may pass to secure the shim in place.

30. A shim as claimed in claim 23 wherein a face of the wedge portion for engagement with the pin is complementarily shaped thereto.

31. A shim as claimed in claim 30 wherein the wedge portion is arcuate.

32. A shim as claimed in claim 31 wherein one side of the shim is arcuate and adapted to be one third to half a complete circle circumference.

33. A shim as claimed in claim 32 wherein the shim has a top bearing surface formed from a first radius of curvature and a lower having a second radius of curvature that is greater than the first.

34. A shim as claimed in claim 33 wherein the first radius of curvature is preferably substantially the same as the radius of the pin.

35. A shim as claimed in claim 22 having an extraction hole which is accessible external to the shim for engagement with a tool for insertion and/or removal of the shim.
